(19) United States
(12) Patent Application Publication
(10) Pub. No.: US 2025/0068151 A1
(43) Pub. Date: Feb. 27, 2025

(54) MEASURING THE PREDICTIVE POWER OF A MODEL

(71) Applicant: Minitab, LLC, State College, PA (US)

(72) Inventors: Senin J. Banga, State College, PA (US); Cheryl L. Pammer, San Diego, CA (US)

(73) Assignee: Minitab, LLC, State College, PA (US)

(21) Appl. No.: 18/236,104

(22) Filed: Aug. 21, 2023

(51) Int. Cl. G05B 19/418

(52) U.S. Cl. CPC G05B 19/41885; G05B 19/4183; G05B 19/4184

(57) ABSTRACT

Selecting an optimal model by acquiring, via a predictive analytics engine of a learning machine, an input dataset, and receiving a number of possible regression models for selection, the input dataset includes a plurality of labeled cases. Each candidate regression which is generated through a forward selection procedure is fitted to the input dataset to describe a relationship between one or more explanatory variable values and response variable values of the input dataset. A predictive power of the possible regression model is measured by computing a usual square coefficient of multiple determination, and either a point estimate of the square cross-validated correlation or a two-sided confidence interval of the square cross-validated correlation associated with the given regression sample. Based on the predictive power, the possible regression model that meets a predictive power threshold is selected as an optimal regression model.

### BACKGROUND

### Technical Field

The present disclosure generally relates to measuring the predictive power of a classical linear model, and more particularly, to selecting an optimal model by acquiring, via a predictive analytics engine of a learning machine, an input dataset to be analyzed and computing the predictive power using the learning machine.

### Description of the Related Art

Predictive models may be used to analyze existing systems and processes and make predictions about future outcomes. The predictive models may be generated using collected and aggregated observations to make predictions. A dependent (output or response) variable and numerous independent (input or explanatory) variables may be present in a collection of observations. A linear function may then be fitted to the observations to describe the relationship between the dependent variable and a set of independent variables.

### SUMMARY

According to an embodiment of the present disclosure, a method is disclosed. The method includes selecting an optimal model by acquiring, via a predictive analytics engine of a learning machine, an input dataset to be analyzed, and receiving a number of possible regression models for selection, the input dataset includes a plurality of labeled cases. The possible regression models may be obtained by performing a forward selection procedure where the selection criterion is based on the models with higher estimates of the square cross-validated correlation (big data) or the models with higher one-sided lower confidence bounds (small to large data). Each possible regression model of the number of possible regression models is fitted, by the predictive analytics engine, to the input dataset to describe a relationship between one or more explanatory variable values and response variable values of the input dataset. A predictive power of the possible regression model is measured by computing a usual square coefficient of multiple determination, and either a point estimate or a two-sided confidence interval of a cross-validated correlation that is based on the usual square coefficient of multiple determination. Based on the predictive power, the possible regression model that meets a predictive power threshold is selected as an optimal regression model.

In an aspect herein, the method includes deploying the developed predictive regression model to a first computing device; monitoring and maintaining the predictive regression model by computing a degradation status of the deployed model based on new input test dataset; and, replacing, responsive to computing that the predictive regression model has degraded, the deployed model with a new model.

According to an embodiment of the present disclosure, a non-transitory computer readable medium and a computer system is disclosed. The non-transitory computer-readable storage medium may cause a computer system to acquire, via a predictive analytics engine of a learning machine, an input dataset to be analyzed, the input dataset includes a plurality of labeled cases. The non-transitory computer-readable storage medium may cause a computer system to receive, a plurality of possible regression models for selection, for each possible regression model of the plurality of possible regression models fit, by the predictive analytics engine the possible regression model to the input dataset to describe a relationship between one or more explanatory variable values and response variable values of the input dataset, and measure a predictive power of the possible regression model by: computing by the predictive analytics engine, a usual square coefficient of multiple determination, and either a point estimate or a one sided or two sided confidence interval for the regression equation square cross-validated correlation that is based on the usual square coefficient of multiple determination.

### BRIEF DESCRIPTION OF THE DRAWINGS

To easily identify the discussion of any particular element or act, the most significant digit or digits in a reference number refer to the figure number in which that element is first introduced. The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps.

FIG. 1 depicts a block diagram of a network of data processing systems in which illustrative embodiments may be implemented.

FIG. 2 depicts a block diagram of a data processing system in which illustrative embodiments may be implemented.

FIG. 3 depicts a block diagram of an application in which illustrative embodiments may be implemented.

FIG. 4 depicts a routine in accordance with illustrative embodiments.

FIG. 5 depicts a block diagram of a configuration for measuring a predictive power of a regression model in accordance with illustrative embodiments.

FIG. 6 depicts a block diagram of a configuration for measuring a predictive power of a regression model in accordance with illustrative embodiments.

FIG. 7A depicts a plot showing a performance of estimators in accordance illustrative embodiments.

FIG. 7B depicts a plot showing a performance of estimators in accordance illustrative embodiments.

FIG. 7C depicts a plot showing a performance of estimators in accordance illustrative embodiments.

FIG. 8A depicts a plot illustrating properties of confidence interval methods for a regression sample square cross-validated correlation in accordance illustrative embodiments.

FIG. 8B depicts a plot illustrating properties of confidence interval methods for a regression sample square cross-validated correlation in accordance illustrative embodiments.

FIG. 9 depicts a plot illustrating simulated bias versus sample size under normality and nonnormality in accordance illustrative embodiments.

FIG. 10A depicts a plot illustrating the effects of nonnormality of predictors on the coverage probability of confidence intervals in accordance illustrative embodiments.

FIG. 10B depicts a plot illustrating the effects of nonnormality of predictors on the coverage probability of confidence intervals in accordance illustrative embodiments.

### DETAILED DESCRIPTION

### Overview

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high-level, without detail, in order to avoid unnecessarily obscuring aspects of the present teachings.

The illustrative embodiments recognize that a measure of the predictive power (or precision) of a regression model may be the square population cross-validated correlation. This may be measured by approximation methods which may be very sensitive to the normal assumption of the predictor data. Other methods include empirical data splitting methods cross validation methods such as k-fold cross-validation. Cross validation involves deciding whether numerical results that quantify hypothesized relationships between variables of data, are acceptable as descriptions of the data for prediction purposes. Generally, an error estimation or “evaluation of residual” for a subject model is made after training the subject model. In this process, a numerical estimate of the difference in predicted and original responses is done. However, this only establishes how well said subject model performs on data used to train it. Due to potential underfitting or overfitting of the data by the subject model, an indication of how well said subject model can generalize unseen data set is not obtainable without a cross validation. A main type of cross validation is the k-Fold cross validation. The illustrative embodiments recognize that, k-Fold cross validation, which typically provides ample data for training the model and leaves ample data for validation, has significant shortfalls due to computationally expensive repetitive model fitting and a restriction on a number of folds that can be chosen for cross validation, leaving little to no options for evaluating big data. K-fold cross-validation and other standard cross-validation methods are thus, computationally expensive in large sample designs due to a requirement for repetitive fitting of models. An exact number of model fitting steps in a cross-validation procedure equals the number of folds making the procedure for a system having a large number of folds, to be significantly computationally intensive and thus prohibitive. In addition, k-fold cross-validation does not use all the data in the multiple fitting of the models and therefore yield inferior estimates compared to analytical methods that are based on all the available data. Presently available systems and solutions do not address these memory and speed needs or provide adequate solutions for these needs.

The illustrative embodiments provide a method that comprises acquiring, via a predictive analytics engine of a learning machine, an input dataset to be analyzed, the input dataset includes a plurality of labeled cases. The method also includes receiving, a plurality of possible regression models for selection. The plurality of regression models may be obtained by performing a forward selection procedure where the selection criterion is based on the models with higher estimates of the square cross-validated correlation (big data) or the models with higher one-sided lower confidence bounds (small to large data). For each possible regression model of the plurality of possible regression models fitting, by the predictive analytics engine the possible regression model to the input dataset to describe a relationship between one or more explanatory variable values and response variable values of the input dataset, and measuring a predictive power of the possible regression model. Based on the predictive power, the possible regression model that meets a predictive power threshold (such as a highest point estimate of the square cross-validated correlation (Big data) or a highest one-sided lower confidence limit for the population square cross-validated correlation (small to large data)) may be selected and deployed an optimal predictive regression model.

The illustrative embodiments provide an analytical closed-form predictive power measurement of models that is significantly easy to implement, and that does not require splitting of an original sample or multiple model fitting and rather uses an estimate of a population square coefficient of multiple correlation based on the entire data. By estimating the square cross-validity correlation for a given estimated regression model and providing corresponding confidence intervals, measurement of the predictive power of regression models may be significantly accelerated, as described herein. This may be applicable not just to small sample designs but also to large data wherein the embodiments may more accurately and more precisely than conventional methods, work in large sample designs. The illustrative embodiments are related to manufacturing and other processes involving measurement of sensor data and other data related to physical quantities and attributes of real-world objects. The illustrative embodiments disclose a closed-form estimator, provide a standard error of estimates, and deliver robust confidence interval methods for measuring the predictive power of a regression model and thus, for monitoring the degradation of a deployed predictive regression model.

An embodiment can be implemented as a software and/or hardware application. The application implementing an embodiment can be configured as a modification of an existing system, as a separate application that operates in conjunction with an existing system, a standalone application, or some combination thereof.

This manner, duration, memory, and significantly accelerated speed benefits of predictive power measurement and degradation monitoring provided herein is unavailable in the presently available methods in the technological field of endeavor pertaining to manufacturing, degradation monitoring and predictive analytics. A method of an embodiment described herein, when implemented to execute on a device or data processing system, comprises substantial advancement of the computational functionality of that device or data processing system in configuring the performance of a predictive analytic platform. In as aspect, once actual response data are available, these data can be used to determine the accuracy of the currently deployed model. Specifically, the square correlation between the actual response and the predicted response can be obtained from the deployed predictive model and compared with the estimate of the square cross-validated correlation (big data) or the lower bound of the square cross-validated correlation (small to large sample) from the currently deployed model. The advantages of estimation simplicity and the ability to estimate robust standard errors and confidence intervals make this approach appealing. When the square cross-validated correlation from a new model containing the most recent data falls below the one-sided lower confidence interval for the square cross-validated correlation of the currently deployed model, statistical evidence shows that the deployed model has degraded and may be updated using the model selection techniques described herein.

The illustrative embodiments are described with respect to certain types of learning machines developing a predictive analytic model based on data records received from a manufacturing station. The illustrative embodiments are also described with respect to other scenes, subjects, measurements, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific surveys, code, hardware, algorithms, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

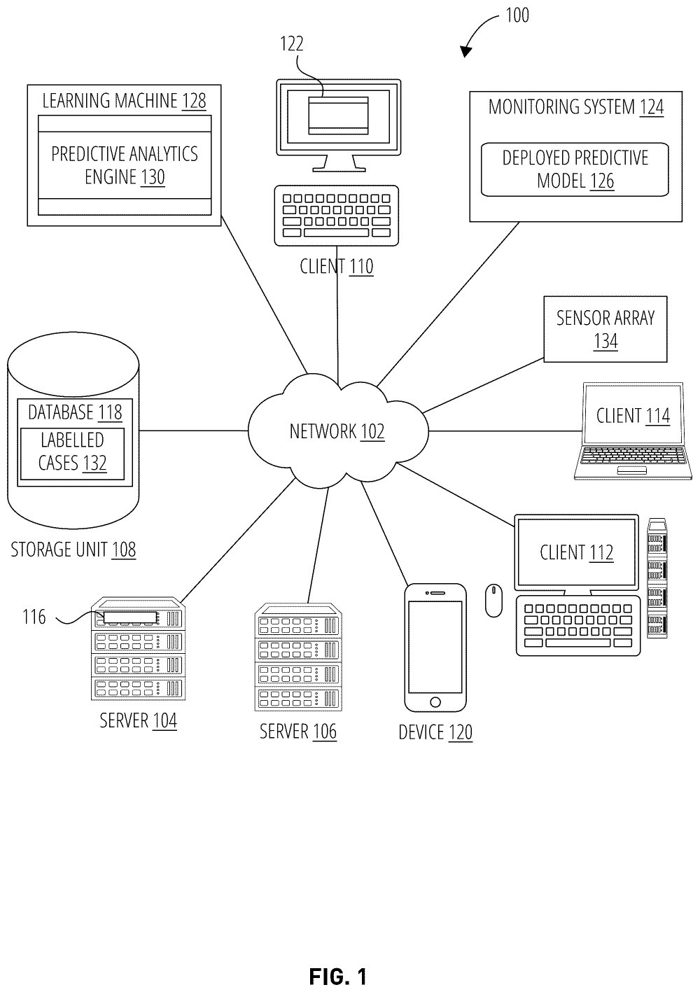

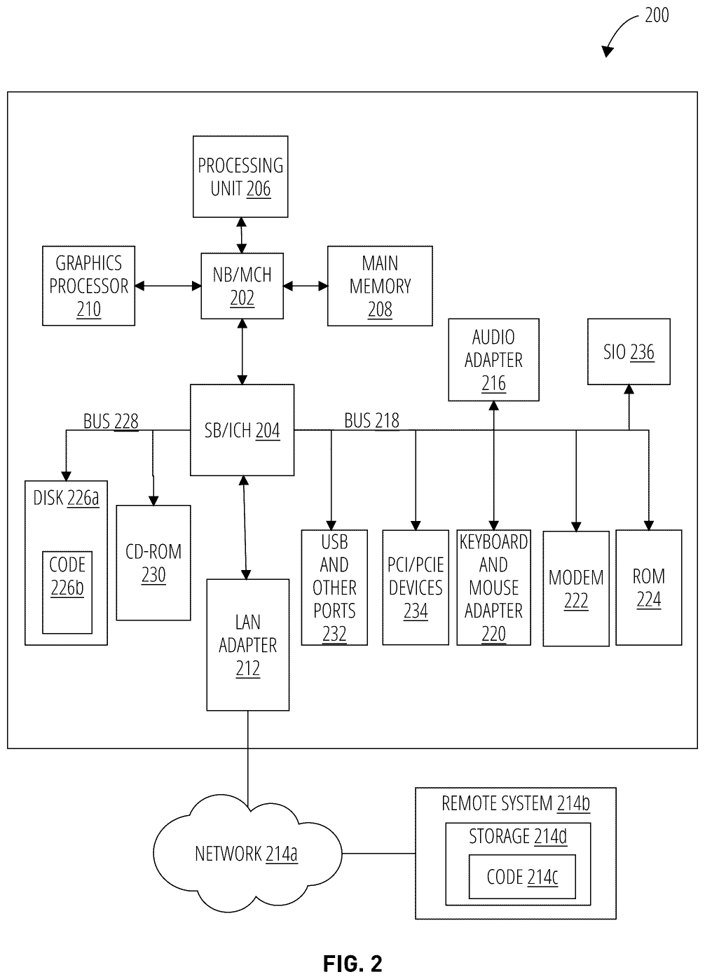

With reference to the figures and in particular with reference to FIG. 1 and FIG. 2, these figures are example diagrams of data processing environments in which illustrative embodiments may be implemented. FIG. 1 and FIG. 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Client 110, client 112, client 114 are also coupled to network 102. A data processing system, such as server 104 or server 106, or clients (client 110, client 112, client 114) may contain data and may have software applications or software tools executing thereon. Server 104 may include one or more GPUs (graphics processing units) for training one or more models.

Only as an example, and without implying any limitation to such architecture, FIG. 1 depicts certain components that are usable in an example implementation of an embodiment. For example, servers and clients are only examples and not to imply a limitation to a client-server architecture. As another example, an embodiment can be distributed across several data processing systems and a data network as shown, whereas another embodiment can be implemented on a single data processing system within the scope of the illustrative embodiments. Data processing systems (server 104, server 106, client 110, client 112, client 114) also represent example nodes in a cluster, partitions, and other configurations suitable for implementing an embodiment.

Device 120 is an example of a device described herein. For example, device 120 can take the form of a smartphone, a tablet computer, a laptop computer, client 110 in a stationary or a portable form, a manufacturing device, or any other suitable device. Any software application described as executing in another data processing system in FIG. 1 can be configured to execute in device 120 in a similar manner. Any data or information stored or produced in another data processing system in FIG. 1 can be configured to be stored or produced in device 120 in a similar manner.

Predictive analytics engine 130 may execute as part of client application 122, server application 116, learning machine 128 or on any data processing system herein. Predictive analytics engine 130 may also execute as a cloud service communicatively coupled to system services, hardware resources, or software elements described herein. Database 118 of storage unit 108 stores one or more sets of labelled cases 132 in repositories for computations herein.

Server Application 116 implements an embodiment described herein. Server Application 116 can use data from storage unit 108 for predictive power computations. Server Application 116 can also obtain data from any client for cross validation. Server Application 116 can also execute in any of data processing systems (server 104 or server 106, client 110, client 112, client 114), such as client application 122 in client 110 and need not execute in the same system as server 104.

Server 104, server 106, storage unit 108, client 110, client 112, client 114, device 120 may couple to network 102 using wired connections, wireless communication protocols, or other suitable data connectivity. Client 110, client 112 and client 114 may be, for example, personal computers or network computers.

In the depicted example, server 104 may provide data, such as boot files, operating system images, and applications to client 110, client 112, and client 114. Client 110, client 112 and client 114 may be clients to server 104 in this example. Client 110, client 112 and client 114 or some combination thereof, may include their own data, boot files, operating system images, and applications. Data processing environment 100 may include additional servers, clients, and other devices that are not shown. Server 104 includes a server application 116 that may be configured to implement one or more of the functions described herein for cross validation in accordance with one or more embodiments.

Server 106 includes a search engine configured to search trained models or databases in response to a query with respect to various embodiments. The data processing environment 100 may also include a dedicated learning machine 128 which comprises a predictive analytics engine 130. The dedicated learning machine 128 may be used for training a model to make predictions. The learning machine 128 may be specially configured to make predictions by applying input data to a predictive analytic model. It may learn to make predictions by constructing the predictive analytic model. It may construct the predictive analytic model by predictive analysis of example data. Various types of predictive analytic models may be constructed and employed by the learning machine 128 to make predictions. For example, the learning machine 128 may construct and employ predictive analytic models including a regression tree and multiple regression models.

An operator of the learning machine 128 can include individuals, however the learning machine 128 may be specially configured to automatically train and monitor regression models using processes described herein without human input. Using closed form routines that reduce or eliminate manual and burdensome human interaction for selecting a best regression model as is described herein, the learning machine 128 may operate automatically to receive labelled cases from manufacturing stations, physical measurement systems, or sensor arrays for model training, deployment and/or monitoring.

The data processing environment 100 may also be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service-oriented architecture where interoperable software components distributed across a network may be packaged together as coherent business applications. Data processing environment 100 may also take the form of a cloud, and employ a cloud computing model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service.

With reference to FIG. 2, this figure depicts a block diagram of a data processing system in which illustrative embodiments may be implemented. Data processing system 200 is an example of a computer, such as server 104, server 106, or client 110, client 112, client 114, monitoring system 124 in FIG. 1, or another type of device in which computer usable program code or instructions implementing the processes may be located for the illustrative embodiments.

Data processing system 200 is also representative of a data processing system or a configuration therein, such as device 120 in FIG. 1 in which computer usable program code or instructions implementing the processes of the illustrative embodiments may be located. Data processing system 200 is described as a computer only as an example, without being limited thereto. Implementations in the form of other devices, such as device 120 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to North Bridge and memory controller hub (NB/MCH) 202 through an accelerated graphics port (AGP) in certain implementations.

In the depicted example, local area network (LAN) adapter 212 is coupled to South Bridge and input/output (I/O) controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and input/output (I/O) controller hub (SB/ICH) 204 through bus 218. Hard disk drive (HDD) or solid-state drive (SSD) 226a and CD-ROM 230 are coupled to South Bridge and input/output (I/O) controller hub (SB/ICH) 204 through bus 228. PCI/PCIe devices 234 may include, for example, Ethernet adapters, add-in cards, and PC cards for notebook computers. PCI uses a card bus controller, while PCIe does not. Read only memory (ROM) 224 may be, for example, a flash binary input/output system (BIOS). Hard disk drive (HDD) or solid-state drive (SSD) 226a and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and input/output (I/O) controller hub (SB/ICH) 204 through bus 218.

Memories, such as main memory 208, read only memory (ROM) 224, or flash memory (not shown), are some examples of computer usable storage devices. Hard disk drive (HDD) or solid-state drive (SSD) 226a, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices. An object oriented or other type of programming system may operate in conjunction with the operating system and provide calls to the operating system from programs or applications executing on data processing system 200.

Instructions for the operating system, the object-oriented programming system, and applications or programs, such as server application 116 and client application 122 in FIG. 1, are located on storage devices, such as in the form of codes 226b on Hard disk drive (HDD) or solid-state drive (SSD) 226a, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory (ROM) 224, or in one or more peripheral devices.

Furthermore, in one case, code 226b may be downloaded over network 214a from remote system 214b, where similar code 214c is stored on a storage device 214d in another case, code 226b may be downloaded over network 214a to remote system 214b, where downloaded code 214c is stored on a storage device 214d.

The hardware in FIG. 1 and FIG. 2 may vary depending on the implementation. Other internal hardware or peripheral devices, such as flash memory, equivalent non-volatile memory, or optical disk drives and the like, may be used in addition to or in place of the hardware depicted in FIG. 1 and FIG. 2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub (NB/MCH) 202. A processing unit may include one or more processors or CPUs.

The depicted examples in FIG. 1 and FIG. 2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and Hard disk drive (HDD) or solid-state drive (SSD) 226a is manifested as a virtualized instance of all or some portion of Hard disk drive (HDD) or solid-state drive (SSD) 226a that may be available in the host data processing system. The host data processing system in such cases is represented by data processing system 200.

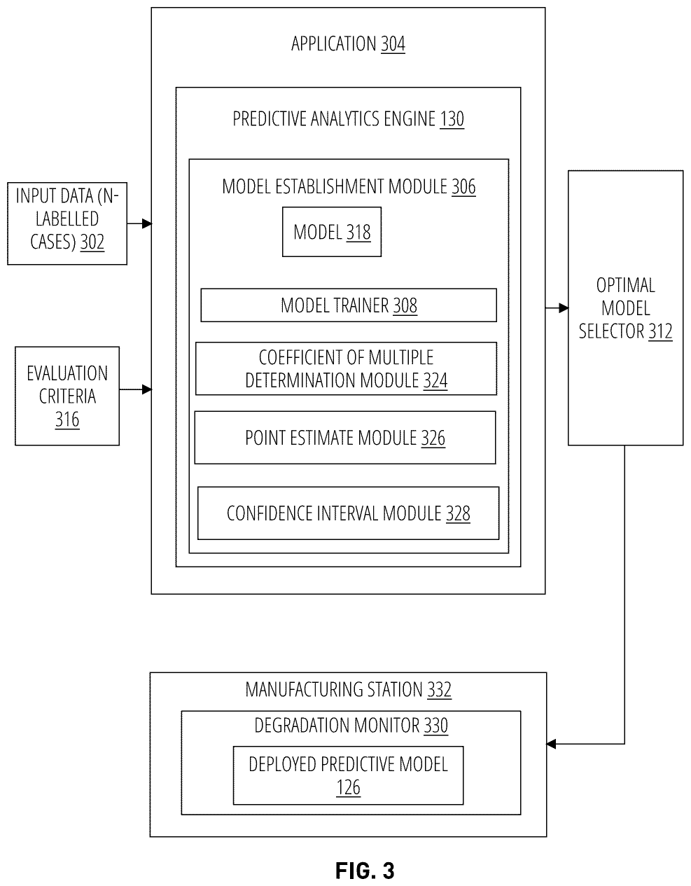

Turning now to FIG. 3, the figure shows an application 304 according to an illustrative embodiment. The application 304 may be embodied as, includes, and/or interacts with a predictive analytics engine 130 which comprises a model establishment module 306, a model trainer 308, a coefficient of multiple determination module 324, a point estimate module 326, and a confidence interval module 328. The components may be functional elements that are functionally distinguishable from one another, and in an actual physical environment, may be incorporated into fewer or more components.

The model establishment module 306 may receive or determine one or more independent variables based on a dataset to be analyzed. The dataset is or includes labelled cases 132. The model establishment module 306 may establish a model 318 showing a relationship between the one or more independent variables and a dependent variable of the dataset. The model establishment module 306 may establish one or more models, which are linear regression models, for assessment of a predictive power thereof. The model establishment module 306 may thus continue to establish a model 318 in an iteration until a terminating condition or evaluation criteria 316 such as the best point estimate or lower confidence bounds are met. Alternatively, received possible models from a forward selection procedure may be evaluated and a model with a point estimate or one-sided lower confidence bound, obtained from a two-sided confidence interval computation as described herein, which meets a threshold may be selected.

The model trainer 308 may train the models 318 using the input data 302 which may comprise a number (e.g., N) labelled cases 132. The model trainer 308, and more generally the predictive analytics engine 130 may employ a formula-based estimator derived from a second order approximation of the mean of the distribution of the population square cross-validated correlation, a random variate. An analytical approximate standard error of estimates, which is conventionally lacking, is also employed. For a given regression sample, the process of determining the point estimate of the fitted equation square cross-validity along with the standard error of the estimate is described hereinafter. Further, the predictive analytics engine 130 utilizes confidence intervals method for a regression sample square cross-validity. Relative to point estimators, confidence intervals may provide information about accuracy and precision of estimates simultaneously. These estimators, corresponding standard error and confidence intervals possess appealing statistical properties and are remarkably robust to non-normality as shown herein, with the estimator outperforming empirical data-splitting cross-validation methods such as the k-fold cross validation. An operator's objective in estimating a fitted regression equation square cross-validity may be to measure the predictive power of the regression model to know if the regression model may be deployed for new or future external data for prediction purposes. For example, if a point estimate is desired, an evaluation criterion 316 such as the following rule may be used to answer the investigator's query. If the estimated square cross-validity is in the interval (0, 0.45) then one may conclude that the fitted equation has a low predictive power; if the estimate is in [0.45, 0.55) the predictive power may be considered acceptable; estimates in [0.55, 0.7) may be considered good; and estimates in the interval [0.7,1) may be described as very good or excellent. Of course, this is only an example and is not meant to be limiting as variations thereof may be possible in view of the descriptions. In other situations where a confidence interval is desired, a lower bound may be calculated to obtain, with some level of confidence, the minimum possible square cross-validity of the fitted regression equation. A moderate minimum value, say 0.5, may be used as a threshold to decide when to deploy the fitted regression. Furthermore, the confidence intervals can be used to develop a model selection criterion for building regression models with greater predictive power. For example, in a forward selection procedure the model with the largest 90 or 95 percent lower confidence bound may be prioritized.

The optimal model selector 312 may be a selector configuration or a regression tree. Responsive to selecting, by an optimal model selector 312, the predictive regression model selected may be deployed predictive model 126 in one or more environments, including a manufacturing station 332 wherein a degradation monitor 330 which may be an instance of the monitoring system 124 of FIG. 1, may monitor the continuing ability of the model to make predictions based on new unseen measurement data.

More specifically, new incoming data, such as data from a sensor array 134 (e.g., Measure data about the amount of oxygen required by microorganisms to decompose organic matter in water, and other data that may be used to forecast process variables in a manufacturing environment or other environment) may be used as a test dataset. Generally, the input data may represent quantitative measurements obtained by an operator using one or more sensors and may be generated and or received automatically in a seamless/automated flow. For example, the measurements/data may be obtained from manufacturer testing or observational data such as data about steel yield strength or balloon rated burst pressures of catheters. A correlation between the predicted values using the deployed predictive model 126 and the actual (observed) response values in the test set may provide a new estimate of the predictive power of the deployed predictive model 126. In an illustrative example, for small to large data sets the new estimate may be compared to the lower bound on the cross-validated correlation associated with the deployed predictive model as described herein. For big data, on the other hand, the new estimate may be compared directly to the (point) estimated cross-validated correlation associated with the deployed predictive model as described herein.

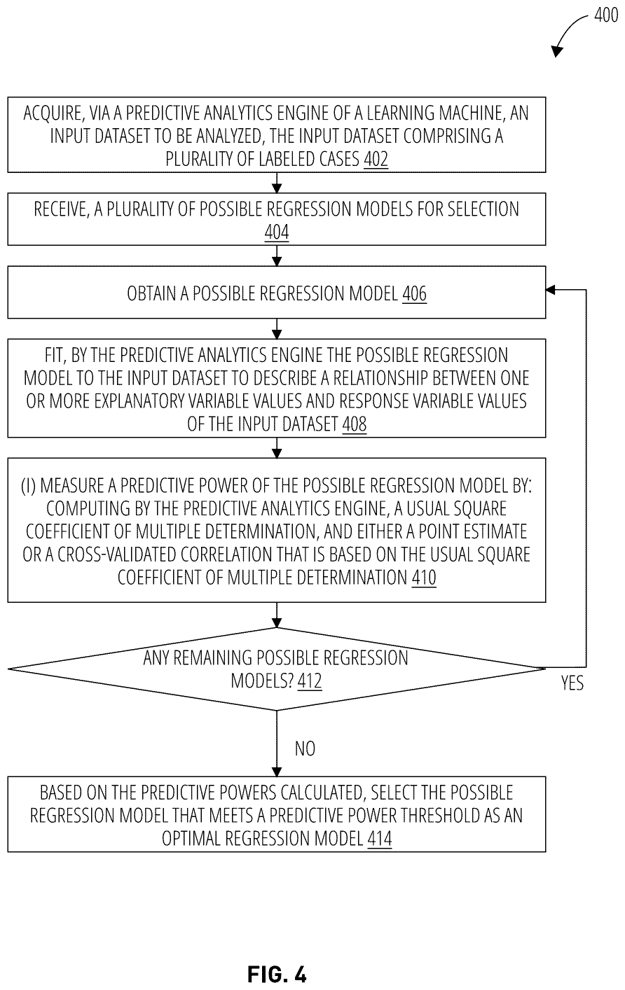

FIG. 4 illustrates a predictive power measurement routine 400 in accordance with illustrative embodiments. In one of more embodiments, the learning machine 128 may be configured to perform the routine.

In block 402, the learning machine 128 is used to acquire an input dataset to be analyzed, the input dataset comprising a plurality of labeled cases. In block 404, a plurality of possible regression models is received by the learning machine 128 for optimal model selection. In block 406, the learning machine 128 iterates through each regression model according to a forward selection algorithm from the plurality of possible regression models and performs block 408-block 410 for the model. In block 408, the regression model is fitted to the input dataset to describe a relationship between one or more explanatory variable values and response variable values of the input dataset. In block 410 a predictive power of the possible regression model is measured by computing a usual square coefficient of multiple determination, and either a point estimate or a two-sided confidence interval for the square cross-validated correlation that is based on the usual square coefficient of multiple determination. When there are no remaining possible regression models (decision block 412), the possible regression model that meets a predetermined predictive power threshold or criteria is selected as the optimal regression model to be deployed.

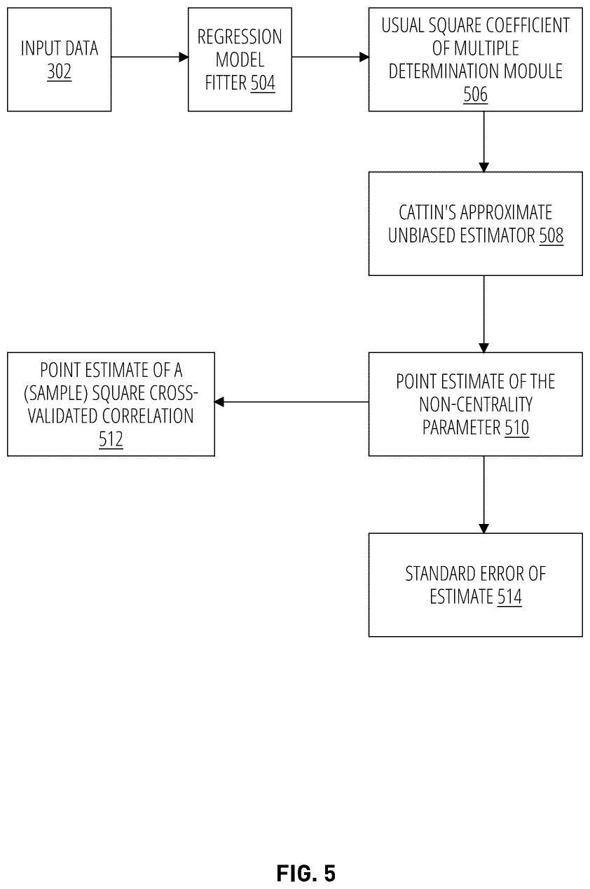

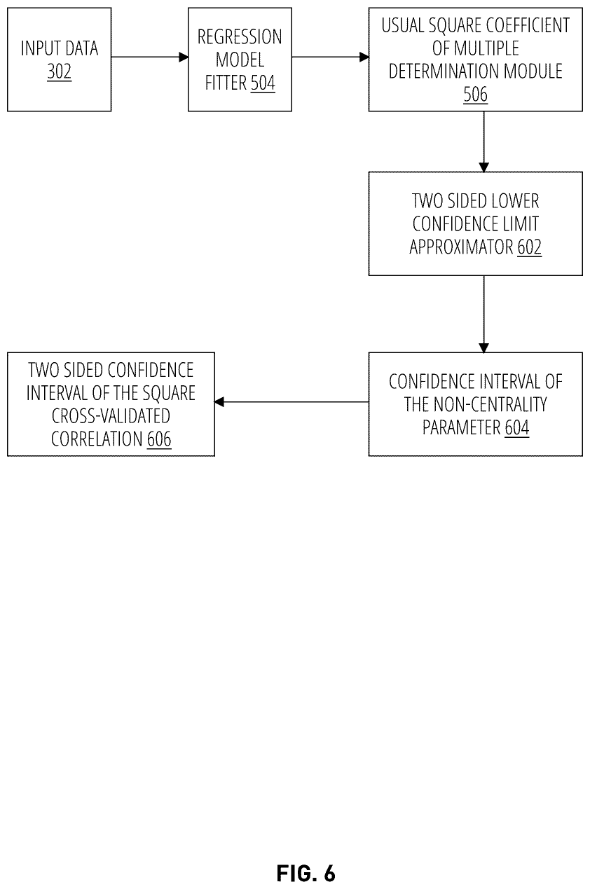

With reference to FIG. 5 and FIG. 6, configurations for computing a point estimate of a (sample) square cross-validated correlation 512 or a two-sided confidence interval of the square cross-validated correlation 606 as a measure of a predictive power of a regression model are described in more detail. Classical linear models may be used to explore a linear relationship between a dependent (or output) variable, y, and a set of p predictor variables denoted by vector x (See FIG. 5, FIG. 6 input data 302). y may be an n×1 vector and x may be an n×P matrix. The number of rows in a design may be referred to herein as the sample size, n, and the number of predictors as P.

Thus, responsive to receiving the input data 302, the regression model fitter 504 may fit the regression model based on said input data 302. The regression model may be denoted by yᵢ=β₀+xᵢ^{T}β+σ²eᵢ, i=1, . . . , n wherein xᵢ is row i of the design matrix X, eᵢ is a standard normal random noise, and the least squares estimates may be obtained as: \hat{β}₀ and β=(\hat{β}₁, . . . , \hat{β}ₚ)^{T}.

A measure of the validity the relationship may be the square population multiple correlation denoted by ρ² which may be the maximum square correlation between y and β^{T}ₓ in the population, where β=(β₁, . . . , βₚ)^{T} is a p-component vector of unknown coefficients parameters to be estimated. A natural point estimator of ρ² is the square (sample) correlation between y and the fitted values \hat{β}Tₓ. It may be denoted by R², the square sample multiple correlation (or coefficient of multiple determination/usual square coefficient of multiple determination) and computed using the usual square coefficient of multiple determination module 506 as shown in FIG. 5 and FIG. 6. R² may measure the goodness of fit of the model and may be determined by

$${R}^{2} = 1 - \frac{S S E}{S S T} , where SSE = {\sum }_{i = 1}^{n} {( {y}_{i} - {\hat{y}}_{i} )}^{2} , and SST = {\sum }_{i = 1}^{n} {( {y}_{i} - \overline{y} )}^{2} .$$

For a regression model that is developed for prediction purposes, an alternative effective measure of predictive power, to the mean squared error of prediction, may be the square population cross-validated multiple correlation. It is, by definition, the square correlation between y and the predicted values \hat{β}^{T}ₓ, where the observations (y, x) were not used in the fitting of the regression model. [symbol] _{c}² may be a random parameter, which is bounded above by ρ². The realized value of [symbol] _{c}² in a regression sample with coefficient vector estimate \hat{β} is unobserved and therefore an unknown parameter, ρ_{c}² (\hat{β}), i.e., the regression sample square cross-validated (multiple) correlation. This may measure the predictive power of a fitted regression equation for the regression sample at hand. Larger values of ρ_{c}²(\hat{β}) may be desired. The illustrative embodiments may provide an improved formula-based point estimator, standard error of estimates, and confidence interval (CI) methods for ρ_{c}² (\hat{β}) that significantly accelerates model selection procedure where a k-fold cross-validation algorithm is typically adopted to select models with greater prediction capability. The formula-based methods improve the speed of the learning machine 128, manufacturing station 332 and monitoring system 124 by providing simpler computations that significantly accelerate model selection and monitoring in a manufacturing environment. The methods alleviate and render unnecessary the data splitting and repetitive model fitting of conventional systems. Rather than partitioning an original sample in training and test sets, all the available observations may be used to fit the model. Then, estimators of ρ_{c}²(\hat{β}) may be formulated as functions of the sample size, the number of predictors, and R², the usual square coefficient of multiple determination.

Responsive to computing the usual square coefficient of multiple determinations R², an approximate unbiased estimator for ρ², specifically a Cattin's approximate unbiased estimator 508 (Rᵤ²) of the population square coefficient of multiple determination may be determined as follows:

$${R}_{u}^{2} = 1 - \frac{( n - 3 ) ( 1 - {R}^{2} )}{n - p - 1} [ 1 + \frac{2 ( 1 - {R}^{2} )}{n - p + 1} + \frac{8 {( 1 - {R}^{2} )}^{2}}{( n - p - 1 ) ( n - p + 3 )} ] .$$

Focusing now of FIG. 5, the point estimate module 326 (See FIG. 3) may be engaged for point estimation. A point estimate of the non-centrality parameter 510 (denoted as \hat{λ}), for the distribution of [symbol] _{c}², may be determined and used to compute a point estimate of a (sample) square cross-validated correlation 512 and a standard error of estimate 514 for predictive power measurement purposes. Specifically, the point estimate of the non-centrality parameter 510 may be computed by \hat{λ}=max [0,kRᵤ²/(1−Rᵤ²)], where k=n−p−2.

Based on the point estimate of the non-centrality parameter 510 (\hat{λ}), the point estimate 512 (denoted as \hat{ρ}_{c}²(\hat{β}), of the (sample) square cross-validated correlation, may be computed using

$${\hat{ρ}}_{c}^{2} ( \hat{β} ) = \frac{\hat{λ} ( 1 + \hat{λ} )}{( \hat{λ} + k ) ( \hat{λ} + p )} [ 1 - \frac{2 ( p - 1 ) \hat{λ}}{{( \hat{λ} + p )}^{2} ( \hat{λ} + 1 )} ] .$$

A standard error of estimate 514 may also be computed using

$$( {\hat{ρ}}_{c}^{2} ) = \frac{1 + 2 \hat{λ} - \hat{μ} ( 2 \hat{λ} + k + p )}{( \hat{λ} + k ) ( \hat{λ} + p )} \sqrt{{V}_{\hat{λ}}} ,$$

wherein

$${V}_{\hat{λ}} = \frac{2}{{( n - 1 )}^{2} ( n - p - 5 )} [ ( n - 1 ) ( 2 n - p - 4 ) {\hat{λ}}^{2} + 2 k ( n - 1 ) ( n - 3 ) \hat{λ} + {k}^{2} ( n - 3 ) p ] , and$$

$$\hat{μ} = \frac{\hat{λ} ( 1 + \hat{λ} )}{( \hat{λ} + p ) ( \hat{λ} + k )} .$$

The point estimate of a (sample) square cross-validated correlation 512 may be a value that falls between 0 and 1. Using the point estimate 512 and the standard error 514 of the point estimate, the optimal model selector 312 may select the model 318 that meets a point estimate and standard error criterion as the optimal model for deployment. For example, the model 318 among a plurality of models that has point estimate of a (sample) square cross-validated correlation 512 that is closest to 1, and a standard error that is deemed negligible (e.g. close to zero depending on the estimate type) may be selected as the optimal model (i.e., the model with the best predictive power) and may be deployed as the deployed predictive model 126.

As shown in FIG. 6, a confidence interval module 328 (See FIG. 3) may be engaged for defining confidence intervals. A two-sided confidence interval of the square cross-validated correlation 606 may be computed as a basis for determining the predictive power of each model of a plurality of possible models. Upon computing the usual square coefficient of multiple determination (R²) similarly to that of FIG. 5, the predictive analytics engine 130 may compute an approximate (1−α)100 percent two-sided CI, [ρ_{L}², ρ_{U}²] for the population square coefficient of multiple determination, ρ², using R² obtained from module 506 and the adjusted F approximation or the adjusted normal approximation methods as described in described in application Ser. No. 18/078,480 which is herein incorporated by reference for background disclosure. Based on the two-sided confident interval approximator 602, a corresponding confidence interval 604 of the non-centrality parameter λ, of the distribution of [symbol] _{c}², may be computed as [λ_{L}, λ_{U}], wherein

$${λ}_{L} = \frac{k {p}_{L}^{2}}{1 - {ρ}_{L}^{2}} , and {λ}_{U} = \frac{k {ρ}_{U}^{2}}{1 - {ρ}_{U}^{2}} .$$

An approximate (1−α)100 percent two-sided CI for the square cross-validated correlation ρ_{c}²(\hat{β})(i.e., the two-sided confidence interval of the square cross-validated correlation 606), may be computed using [μ(ρ_{L}²), μ(ρ_{U}²)] where

$$μ ( {ρ}_{L}^{2} ) = \frac{{λ}_{L} ( 1 + {λ}_{L} )}{( {λ}_{L} + k ) ( {λ}_{L} + p )} [ 1 - \frac{2 ( p - 1 ) {λ}_{L}}{{( {λ}_{L} + p )}^{2} ( {λ}_{L} + 1 )} ] and$$

$$μ ( {ρ}_{U}^{2} ) = \frac{{λ}_{U} ( 1 + {λ}_{U} )}{( {λ}_{U} + k ) ( {λ}_{U} + p )} [ 1 - \frac{2 ( p - 1 ) {λ}_{U}}{{( {λ}_{U} + p )}^{2} ( {λ}_{U} + 1 )} ] .$$

Unlike the point estimate of a (sample) square cross-validated correlation 512 which provides a rough estimate of the corresponding regression equation square cross-validity, a 95% two-sided confidence interval for the square cross-validated correlation 606 provides a range a values that may cover the true population square cross-validity with a 95% confidence level. Thus, one can infer with a 95% confidence that the minimum of the prediction power is the lower bound of the confidence interval, and the maximum of the prediction power is the upper bound of the confidence interval. The width of the interval may be interpreted as the magnitude of the prediction power being estimated as well as the precision of the estimated prediction power. A point estimate, however, is most useful in big data scenarios where a confidence interval may be so narrow that it is not informative. In an illustrative example, the model 318 among the plurality of models with the highest computed lower bounds for the square cross-validated correlation 606 may be selected as the optimal model. For a given estimated regression equation, such a lower bound may be interpreted as the minimum possible value of [symbol] with a 100(1−α) percent confidence. By the methods described herein, a new confidence interval method for the unknown parameter may be provided. The new point estimator, corresponding standard error, and confidence intervals possess appealing statistical properties, are remarkably robust to non-normality, and significantly outperform empirical data-splitting cross-validation methods such as the k-fold cross validation.

In an aspect, the robustness properties of the mean of the distribution of [symbol] _{c}² may be observed in an investigation wherein expected means of the distribution of [symbol] _{c}² are determined on the premise that the predictor data are normally distributed. The expected means are then compared to the (actual) simulated means of the distribution of [symbol] _{c}² when predictor data are generated from the multivariate normal distribution (baseline distribution), the multivariate lognormal distribution or the multivariate t distribution with 5 degrees freedom. When the predictor data are drawn from the multivariate normal distribution the difference between expected and simulated means should be very closed to zero. When the predictor data are drawn from the multivariate lognormal or t distribution with 5 degrees freedom, however, the theoretical and simulated means should be very different unless the distribution of [symbol] _{c}² can withstand nonnormality. The simulation included two extremely small sample designs (n=20, p=10) and (n=60, p=50) and two moderately small sample designs (n=60, p=10) and (n=60, p=5). In addition, the true square population multiple correlation, ρ², was varied from 0.1 to 0.9 in steps of 0.2. The simulation results are shown in Table 1.

TABLE 1
Difference between expected and simulated means of [symbol] _{c}² for predictor
data simulated from the multivariate normal, lognormal, and t distribution with 5 degrees
of freedom (t with 5 DF) while varying ρ² from 0.1 to 0.9 in steps of 0.2.

| | | | | | |
|---|---|---|---|---|---|
| Mean | ρ² = 0.1 | ρ² = 0.3 | ρ² = 0.5 | ρ² = 0.7 | ρ² = 0.9 |

Extremely Small Sample Design (n = 20, p = 10)

| | | | | | | |
|---|---|---|---|---|---|---|
| Distribution | Theoretical | 0.01627 | 0.09164 | 0.23729 | 0.46955 | 0.79902 |
| Normal | Simulated | 0.01824 | 0.10254 | 0.25552 | 0.48546 | 0.80329 |
| | Difference | −0.00198 | −0.01089 | −0.01822 | −0.01592 | −0.00428 |
| Lognormal | Simulated | 0.01686 | 0.09304 | 0.23391 | 0.45502 | 0.78261 |
| | Difference | −0.00060 | −0.00140 | 0.00339 | 0.01452 | 0.01640 |
| t with 5 DF | Simulated | 0.01641 | 0.08878 | 0.22381 | 0.44051 | 0.77244 |
| | Difference | −0.00014 | 0.00286 | 0.01348 | 0.02904 | 0.02657 |

Moderately Small Sample Design (n = 60, p = 10)

| | | | | | | |
|---|---|---|---|---|---|---|
| Distribution | Theoretical | 0.03866 | 0.20752 | 0.42008 | 0.64756 | 0.88159 |
| Normal | Simulated | 0.03956 | 0.20927 | 0.42143 | 0.64835 | 0.88185 |
| | Difference | −0.00090 | −0.00176 | −0.00135 | −0.00079 | −0.00025 |
| Lognormal | Simulated | 0.03790 | 0.20364 | 0.41498 | 0.64346 | 0.87997 |
| | Difference | 0.00076 | 0.00388 | 0.00510 | 0.00410 | 0.00162 |
| t with 5 DF | Simulated | 0.03679 | 0.19983 | 0.41073 | 0.64033 | 0.87879 |
| | Difference | 0.00187 | 0.00769 | 0.00935 | 0.00723 | 0.00280 |

Extremely Small Sample Design (n = 60, p = 50)

| | | | | | | |
|---|---|---|---|---|---|---|
| Distribution | Theoretical | 0.00365 | 0.02423 | 0.07562 | 0.19655 | 0.53498 |
| Normal | Simulated | 0.00402 | 0.02802 | 0.08709 | 0.21904 | 0.55578 |
| | Difference | −0.00038 | −0.00379 | −0.01147 | −0.02248 | −0.02079 |
| Lognormal | Simulated | 0.00396 | 0.02737 | 0.08492 | 0.21397 | 0.54745 |
| | Difference | −0.00032 | −0.00315 | −0.00930 | −0.01742 | −0.01247 |
| t with 5 DF | Simulated | 0.00335 | 0.02090 | 0.06369 | 0.16462 | 0.46542 |
| | Difference | 0.00029 | 0.00333 | 0.01193 | 0.03193 | 0.06956 |

Moderately Small Sample Design (n = 60, p = 5)

| | | | | | | |
|---|---|---|---|---|---|---|
| Distribution | Theoretical | 0.05925 | 0.25382 | 0.46436 | 0.67790 | 0.89250 |
| Normal | Simulated | 0.05973 | 0.25424 | 0.46463 | 0.67805 | 0.89254 |
| | Difference | −0.00048 | −0.00042 | −0.00027 | −0.00015 | −0.00004 |
| Lognormal | Simulated | 0.05761 | 0.24904 | 0.45992 | 0.67492 | 0.89143 |
| | Difference | 0.00164 | 0.00478 | 0.00444 | 0.00299 | 0.00107 |
| t with 5 DF | Simulated | 0.05783 | 0.25019 | 0.46108 | 0.67575 | 0.89174 |
| | Difference | 0.00142 | 0.00364 | 0.00328 | 0.00215 | 0.00076 |

The dimensions of the samples varied from extremely small to relatively small. The expected means were computed assuming that the data come from the multivariate normal distribution. The simulated means were computed based on the specified distributional model. Small differences in the nonnormal simulated models indicate that the mean of [symbol] _{c}² resists nonnormality. Thus, results show that the mean of the distribution of [symbol] _{c}² ris remarkably robust to nonnormality.

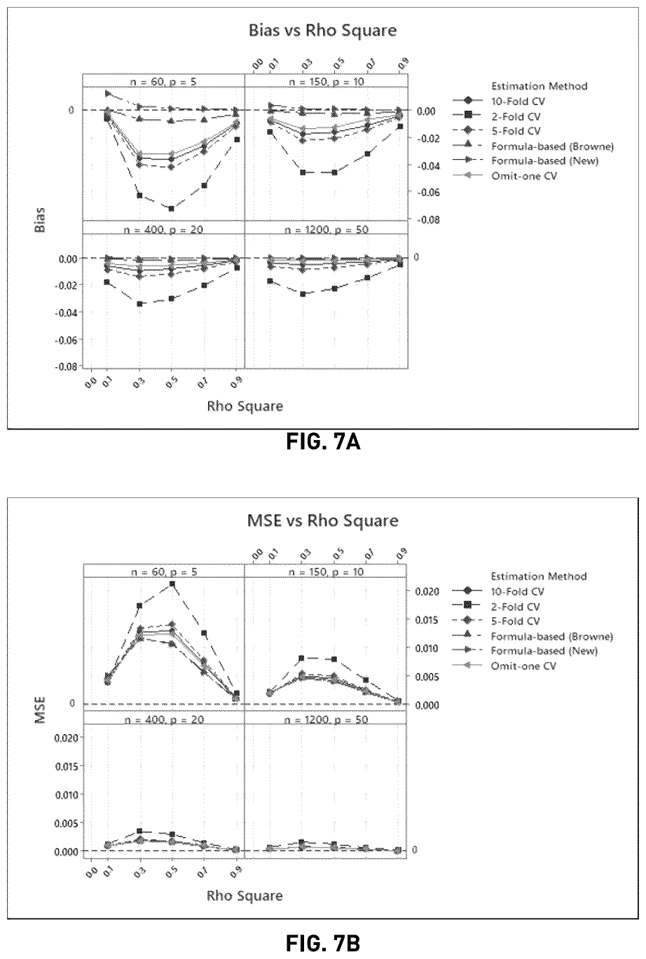

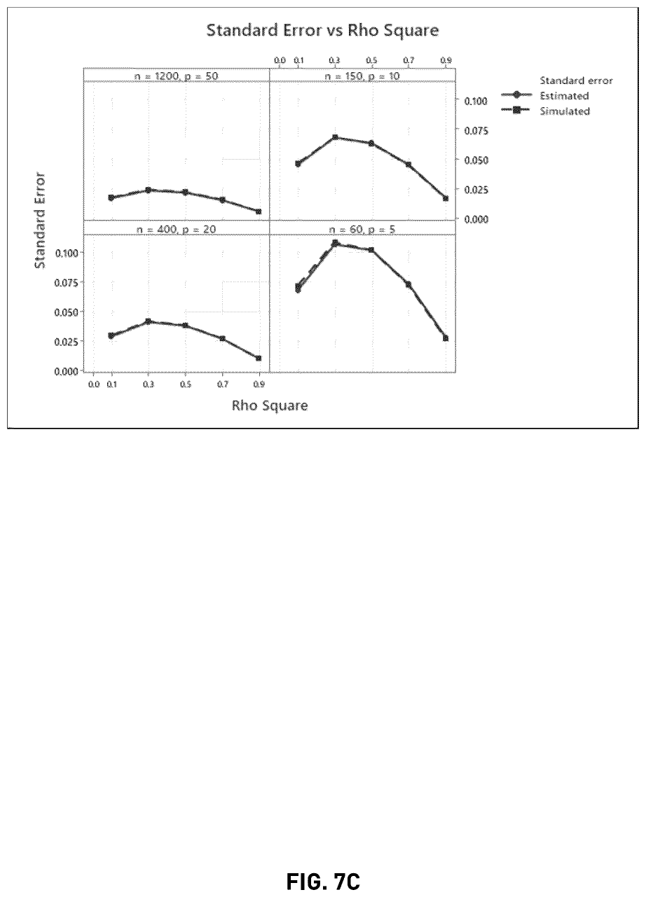

Further, the performance of methods described herein may be compared under the assumptions that regressors data are from multivariate normal populations and to evaluate the performance for of some procedures under non-normality. The performance of an estimator may be assessed in terms of its simulated average bias and mean square error (MSE). Estimators with smaller average bias and MSE are preferred. As shown in FIG. 7A-FIG. 7B, the estimators perform well. The largest absolute average bias (0.07) and the largest MSE (0.02) is achieved by the 2-fold CV (cross-validation) estimation method under the smaller sample design. A closer look reveals that the proposed new formula-based method yields the best results in all the sample designs. It is followed by the conventional Browne's estimator. The Omit-one CV method, which is a k-fold CV with k n, is the third best method followed by the 10-fold CV, the 5-fold CV and the 2-fold CV. In addition, FIG. 6.1.1.c compares the simulated standard errors to the estimated standard errors. Since the simulated standard errors are very similar across the different estimation methods, we only compare the new method simulated standard errors to the estimated standard errors. FIG. 7C shows that the simulated and estimated standard error curves are practically indistinguishable for all the sample designs.

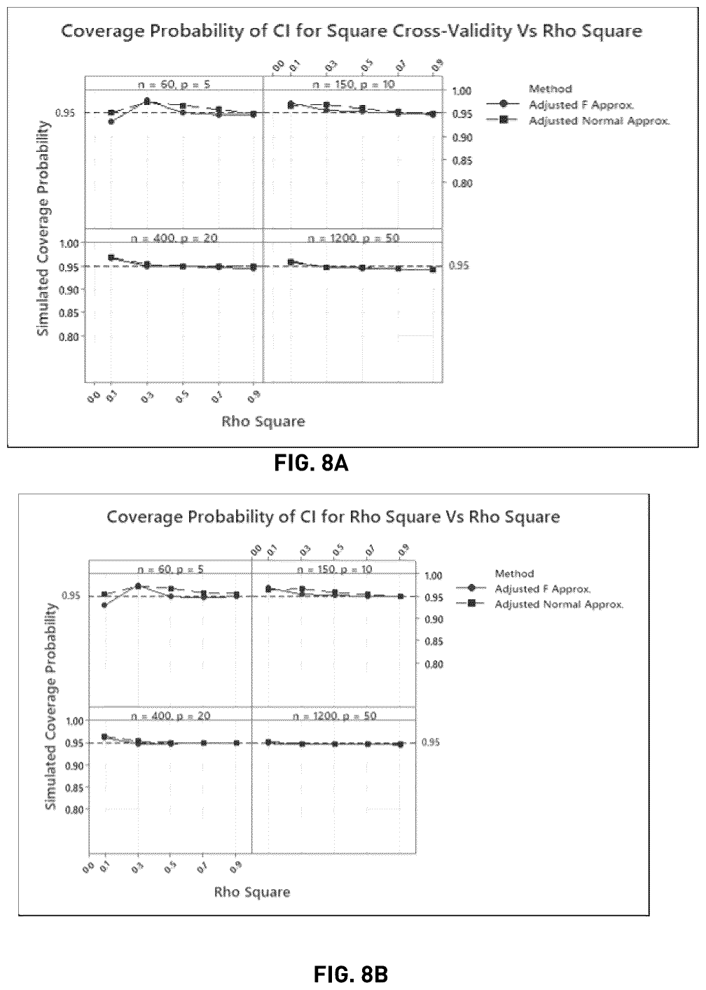

The performance of Confidence intervals may be assessed by evaluating the coverage properties of the confidence intervals for π_{c}² (\hat{β}) in various sample designs and values of the square population multiple correlation, ρ². FIG. 8A-FIG. 8B show that the confidence interval methods for a regression sample square cross-validated correlation, ρ_{c}² (\hat{β}), have very good coverage probability properties. The confidence intervals for ρ_{c}²(\hat{β}) are obtained from the adjusted F approximation and adjusted normal approximation confidence interval methods for ρ² proposed. These confidence intervals are used because they perform well for normal and nonnormal predictor data. As the sample size increases, the coverage probability curves approach the reference line at the targeted nominal coverage probability (0.95) level.

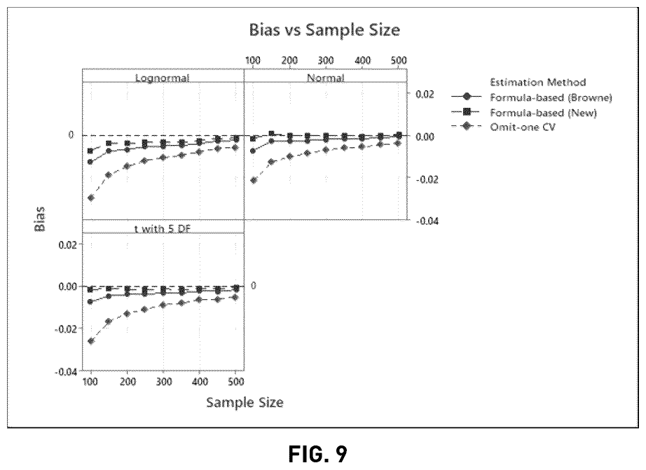

Further, the impact of non-normality on the performance of the new method, Browne's formula-based method and the omit-one CV method may be compared. FIG. 9 illustrates simulated bias versus sample size under normality and nonnormality. The true square population multiple correlation, ρ², in each of the three models is fixed at a moderate value (ρ²=0.5). The number of predictors is fixed at 10 while the design rows vary from 100 to 500 in steps of 50. The results show that the new estimator described herein is the least affected by nonnormality.

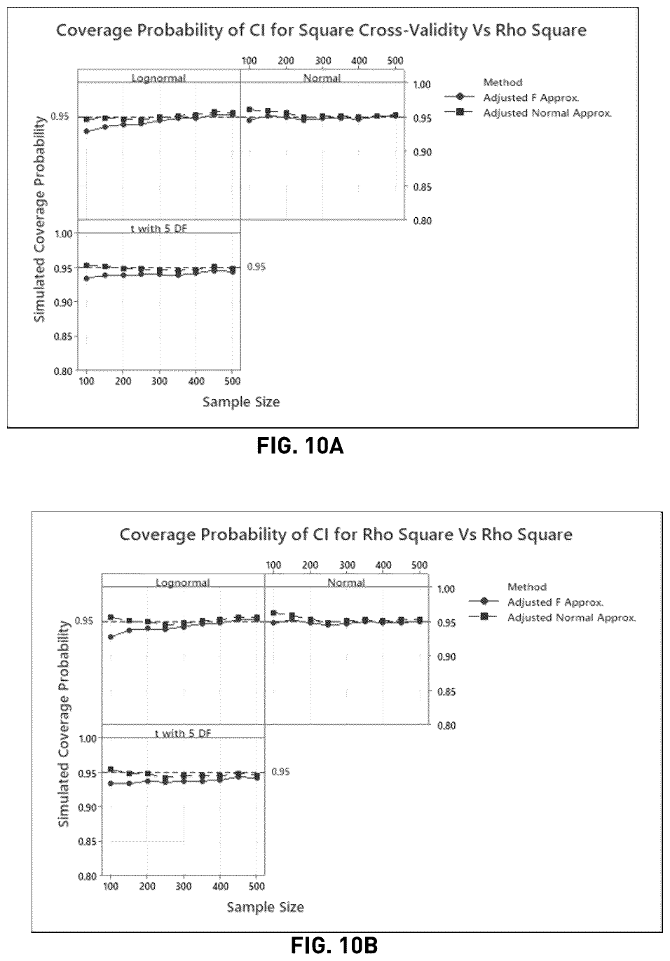

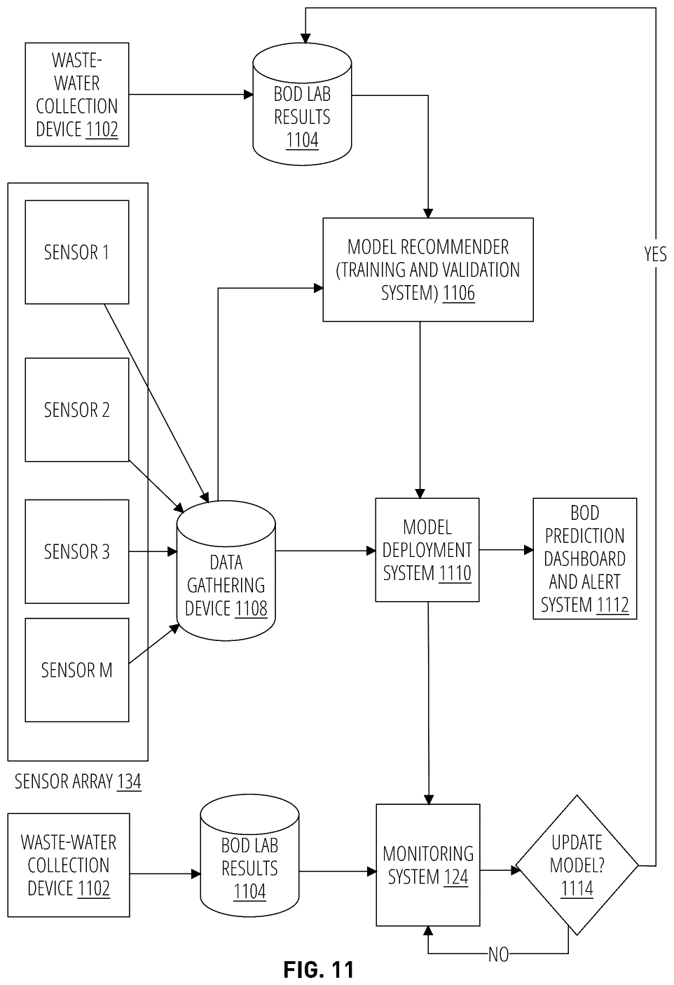

FIG. 10A and FIG. 10B, illustrate the effects of nonnormality of the predictors on the coverage probability of the confidence intervals for the square sample cross-validated correlation, ρ_{c}² (\hat{β}). Since the robustness properties of these Cis may hinge in part on the robustness properties of the Cis for the square population multiple correlation, ρ², the achieved simulated coverage probabilities associated with the confidence intervals (Cis) for ρ² are shown. In FIG. 10A, achieved simulated coverage probability of 95 percent Cis for ρ_{c}²(\hat{β}) are plotted against sample size (n). The number of predictors is fixed at 10 and the true value of ρ² is fixed at the moderate value of 0.5. The adjusted F approximation and the adjusted normal approximation CI methods are subjected to normal and nonnormal predictor data to evaluate their robustness properties to nonnormality. The results show that the two methods achieved similar coverage probabilities across distribution models. In addition, the achieved coverage probabilities in nonnormal models fall near the targeted nominal level. In FIG. 10B, achieved simulated coverage probability of 95 percent C is for ρ² are plotted against sample size (n). The number of predictors is fixed at 10 and the true value of ρ² is fixed at the moderate value of 0.5. The adjusted F approximation and the adjusted normal approximation CI methods are subjected to normal and nonnormal predictor data to evaluate their robustness properties to nonnormality. In general, the adjusted normal approximation CI method tend to outperform the adjusted F approximation method for nonnormal data.

Turning back to FIG. 3, responsive to selecting the optimal model via methods described herein, the model is cross-validated, deployed as a deployed predictive model 126 and monitored in real-time via a degradation monitor 330. The significantly faster model evaluation process provided by the use of the one-time formula-based computation rather than repetitive traditional k-fold cross validation allows easy selection and deployment of models for various environment. The models may be integrated into a larger system or manufacturing station comprising a plurality of sensors and used for real-time predictions. The degradation monitor 330 may monitor the model's performance in production and making necessary adjustments to maintain its accuracy and effectiveness. In an example, as shown in FIG. 11, monitoring the biochemical oxygen demand (BOD) in wastewater is crucial for ensuring compliance with environmental regulations and maintaining responsible waste management practices. BOD monitoring is a several step process. First, wastewater samples are collected by the waste-water collection device 1102 in strategic areas, such as where raw materials are processed, reactors are used, and where final products are manufactured. Composite samples over a specified time period are gathered to provide an accurate representation of the wastewater's characteristics. Once samples are gathered, they are sent to a lab and incubated for a typical time period of, for example, five days at a controlled temperature. The initial and final dissolved oxygen (DO) levels are measured at the start and end of that incubation period. The difference between the initial and final DO concentrations reflects the oxygen consumed by microorganisms during that incubation period. BOD is then calculated as a function of that difference. Because BOD requires a multi-day incubation period in order to obtain accurate measurements, it is imperative to use other process measurements to estimate BOD in real-time in order to provide immediate corrective action when problems occur. For example, metrics such as feed rate, mill speed, chamber temperature, vibration levels, and other operating parameters in the milling process used to reduce raw materials into the desired particle size before further processing have a significant impact on BOD in the resulting wastewater. However, unlike BOD, sensors such as sensors of sensor array 134 and other monitoring equipment can track these key parameters in real time during the milling process through the use of a data gathering device 1108. A predictive regression model (not shown), created based on data collected by waste-water collection device 1102 for model creation, that accurately predicts resulting BOD using data available in real time early in the process (from real time data obtained from data gathering device 1108) can inform decisions about adjusting downstream processes before problems occur. Once the actual BOD lab results 1104 are available from ongoing monitoring performed based on waste-water collected by the waste-water collection device 1102, these data can be used by the monitoring system 124 to determine the accuracy of the currently deployed model. Specifically, the square correlation between the actual response and the predicted response obtained from the deployed predictive regression model can be computed and compared with the estimate of the square cross-validated correlation (big data) or the lower bound of the square cross-validated correlation (small to large sample) from the currently deployed model. The advantages of estimation simplicity and the ability to estimate robust standard errors and confidence intervals make this approach appealing. When the square cross-validated correlation from a new model containing the most recent data falls below the one-sided lower confidence interval for the square cross-validated correlation of the currently deployed model, statistical evidence exists that the deployed model has degraded and should be updated 1114 using the model selection technique described herein wherein the model recommender (training and validation system) 1106 recommends a new model for deployment by the model deployment system 1110. The deployed model then predicts and sends alerts about BOD information as shown by the BOD prediction dashboard and alert system 1112. Of course, this is applicable to other medium such as gaseous media that may use a sensor array 134 to monitor and predict response values of various physical, chemical or biological metrics and thus, biochemical oxygen demand is not meant to be limiting as variations thereof may be obtained in light of the descriptions herein. Turning back to FIG. 3, the correlation between the predicted values using the predictive model and the actual (observed) response values in the test set may provide a new estimate of the predictive power of the deployed predictive model 126. For small to large data sets the new estimate may be compared to, for example, the lower bound on the cross-validated correlation associated with the deployed predictive model. For big data, on the other hand, the new estimate may be compared to, for example, the (point) estimated cross-validated correlation associated with the deployed predictive model.

Any specific manifestations of these and other similar example processes are not intended to be limiting to the invention. Any suitable manifestation of these and other similar example processes can be selected within the scope of the illustrative embodiments.

Thus, a computer implemented method, system or apparatus, and computer program product are provided in the illustrative embodiments for selecting an optimal model by measuring a predictive power of the model and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser, or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on a dedicated monitoring system 124 or user's computer, partly on the user's computer or monitoring system 124 as a stand-alone software package, partly on the user's computer and partly on a remote computer or entirely on the remote computer or server, etc. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

What is claimed is:

1. A method comprising:
acquiring, via a predictive analytics engine of a learning machine, an input dataset to be analyzed, the input dataset comprising a plurality of labeled cases;
receiving, a plurality of possible regression models for selection;
for each possible regression model of the plurality of possible regression models:
fitting, by the predictive analytics engine the possible regression model to the input dataset to describe a relationship between one or more explanatory variable values and response variable values of the input dataset; and
measuring a predictive power of the possible regression model by: computing by the predictive analytics engine, a usual square coefficient of multiple determination, and either a point estimate or a two-sided confidence interval of a square cross-validated correlation that is based on the usual square coefficient of multiple determination; and
based on the predictive power, selecting the possible regression model that meets a predictive power threshold as an optimal regression model.

2. The method of claim 1, wherein the point estimate of the cross-validated correlation is computed, and the predictive power threshold is a highest value of the point estimate of the cross-validated correlation among a set of other point estimates of the cross-validated correlation.

3. The method of claim 1, wherein the degradation status is computed by computing a correlation between a plurality of predicted values using the regression model and a plurality of corresponding actual response values in the input test dataset

4. The method of claim 1, wherein the new input test data comprises new unseen observations that have a potential of degrading the model.

5. The method of claim 4, further comprising:
receiving the new input test data from a sensor array.

6. The method of claim 1, wherein the input dataset is a plurality of measurements obtained from a manufacturing station.

7. The method of claim 1, further comprising:
deploying the regression model to a first computing device;
monitoring and maintaining the regression model by computing a degradation status of the deployed model based on new input test dataset; and,
replacing, responsive to computing that the regression model has degraded, the deployed model with a new model.

8. The method of claim 1, wherein the point estimate of the cross-validated correlation is computed, and the predictive power threshold is a predetermined value for the point estimate of the cross-validated correlation.

9. The method of claim 1, wherein the point estimate of the cross-validated correlation is computed based on computing a point estimate of a non-centrality parameter, \hat{λ}.

10. The method of claim 9, wherein the point estimate of the cross-validated correlation (\hat{ρ}_{c}²(\hat{β})) is computed using
$${\hat{ρ}}_{c}^{2} ( \hat{β} ) = \frac{\hat{λ} ( 1 + \hat{λ} )}{( \hat{λ} + k ) ( \hat{λ} + p )} [ 1 - \frac{2 ( p - 1 ) \hat{λ}}{{( \hat{λ} + p )}^{2} ( \hat{λ} + 1 )} ] ,$$
wherein k=n−p−2, wherein n is a sample size, and wherein p is a number of predictors in a design.

11. The method of claim 9, wherein point estimate of a non-centrality parameter \hat{λ} is computed based on a Cattin's approximate unbiased estimator of a population square coefficient of multiple determination, Rᵤ².

12. The method of claim 11, further comprising:
computing a standard error of the point estimate of the cross-validated correlation based on the point estimate of the non-centrality parameter.

13. The method of claim 1, wherein the two-sided confidence interval of the square cross-validated correlation is computed, and the predictive power threshold is a one-sided lower bound of the square cross-validated correlation.

14. The method of claim 1, wherein the two-sided confidence interval of the square cross-validated correlation is computed based on computing an approximate (1−α)100 percent two-sided CI, [(μ(ρ_{L}²), μ(ρ_{U}²)], for a population square coefficient of multiple determination.

15. The method of claim 14, wherein the two-sided confidence interval is computed using
$$μ ( {ρ}_{L}^{2} ) = \frac{{λ}_{L} ( 1 + {λ}_{L} )}{( {λ}_{L} + k ) ( {λ}_{L} + p )} [ 1 - \frac{2 ( p - 1 ) {λ}_{L}}{{( {λ}_{L} + p )}^{2} ( {λ}_{L} + 1 )} ] and$$
$$μ ( {ρ}_{U}^{2} ) = \frac{{λ}_{U} ( 1 + {λ}_{U} )}{( {λ}_{U} + k ) ( {λ}_{U} + p )} [ 1 - \frac{2 ( p - 1 ) {λ}_{U}}{{( {λ}_{U} + p )}^{2} ( {λ}_{U} + 1 )} ] ,$$
$$wherein {λ}_{L ( or U )} = \frac{k {ρ}_{L ( or U )}^{2}}{1 - {ρ}_{L ( or U )}^{2}}$$
wherein k=n−p−2, wherein a is a sample size, and wherein P is a number of predictors in a design.

16. The method of claim 14, wherein the two-sided confidence interval of the square cross-validated correlation is further computed based on computing a confidence interval for a non-centrality parameter of a distribution of a population square cross-validated correlation.

17. A non-transitory computer-readable storage medium, the computer-readable storage medium including instructions that when executed by a computer, cause the computer to:
acquire, via a predictive analytics engine of a learning machine, an input dataset to be analyzed, the input dataset comprising a plurality of labeled cases;
receive, a plurality of possible regression models for selection;
for each possible regression model of the plurality of possible regression models:
fit, by the predictive analytics engine the possible regression model to the input dataset to describe a relationship between one or more explanatory variable values and response variable values of the input dataset; and
measure a predictive power of the possible regression model by: computing by the predictive analytics engine, a usual square coefficient of multiple determination, and either a point estimate or a two-sided confidence interval of a square cross-validated correlation that is based on the usual square coefficient of multiple determination; and
based on the predictive power, select the possible regression model that meets a predictive power threshold as an optimal regression model.

18. The non-transitory computer-readable storage medium of claim 17, wherein the computer is caused to further:
deploy the regression model to a first computing device;
monitor and maintaining the regression model by computing a degradation status of the deployed model based on new input test dataset; and,
replace, responsive to computing that the regression model has degraded, the deployed model with a new model.

19. A computer system comprising:
a learning machine comprising a predictive analytics engine;
a processor; and
a memory storing instructions that, when executed by the processor, configure the computer system to:
acquire, via the predictive analytics engine of the learning machine, an input dataset to be analyzed, the input dataset comprising a plurality of labeled cases;
receive, a plurality of possible regression models for selection;
for each possible regression model of the plurality of possible regression models:
fit, by the predictive analytics engine the possible regression model to the input dataset to describe a relationship between one or more explanatory variable values and response variable values of the input dataset; and
measure a predictive power of the possible regression model by: computing by the predictive analytics engine, a usual square coefficient of multiple determination, and either a point estimate or a two-sided confidence interval of a square cross-validated correlation that is based on the usual square coefficient of multiple determination; and
based on the predictive power, select the possible regression model that meets a predictive power threshold as an optimal regression model.

20. The computer system of claim 19, wherein the computer system is further configured to:
deploy the regression model to a first computing device;
monitor and maintaining the regression model by computing a degradation status of the deployed model based on new input test dataset; and,
replace, responsive to computing that the regression model has degraded, the deployed model with a new model.
